(19) United States
(12) Patent Application Publication
(10) Pub. No.: US 2002/0016778 A1
(43) Pub. Date: Feb. 7, 2002

(54) Business transaction device, system, methods, information recording medium and program products

(76) Inventors: Izumi Konno, Tokyo (JP); Masanori Suwa, Tokyo (JP); Hiroaki Yato, Tokyo (JP)

Correspondence Address: McGinn & Gibb, PLLC, Suite 200, 8321 Old Courthouse Road, Vienna, VA, 22182-3817, US

(21) Appl. No.: 09/789,668

(22) Filed: Feb. 22, 2001

(30) Foreign Application Priority Data
Aug. 1, 2000 (JP) 12-237638

(51) Int. Cl. G06F 17/60

(52) U.S. Cl. 705/80; 705/4; 705/39; 705/40; 705/53

(57) ABSTRACT

A method (and system and program product) includes a recording portion for recording information of a contract concluded between a supplier and a buyer of merchandise, a storing portion for storing bills and certificates issued with respect to the requests for services provided associated with fulfillment of the contract, first virtual accounts to which prices classified by each contract are transferred virtually, and second virtual accounts to which prices classified by each the suppliers of merchandise and by each service provider are transferred virtually are provided. A remittance from the buyer with respect to third virtual accounts, which are assigned for settlements based on the contract information, is transferred as a virtual fund to the first virtual accounts being classified by contracts, and is allotted to the second virtual accounts being classified by each supplier of the merchandise and by each service provider. Then, the bills and certificates stored in the storing portion are returned to the service providers or forwarded to the buyer and supplier. Therefore, exchanging, for example, prices of merchandise, freight charges, insurance premiums, security deposits, and the like can be conducted at any time and minimum risk occurs between the time of transportation and delivery of the merchandise.

### BACKGROUND OF THE INVENTION

1. Field of the Invention

The present invention relates to a business transaction device, system, methods, information recording medium and program products for transacting merchandise, and more particularly to the technology of a business transaction for transacting merchandise by using a network to handle bills and/or guarantee certificates issued with respect to requests for services that are associated with fulfillment of contracts concerning the business transaction.

2. Description of the Related Art

The current state of a business transaction under an FOB (Free On Board) condition, which is one of the terms of trade, is described below. That is, FOB is a condition in which ownership of the merchandise and bearing of expenses and risks are transferred to a buyer of the merchandise when a supplier of the merchandise loads a designated ship with the merchandise at the supplier's own expense and responsibility, and completes delivery of the merchandise.

FIG. 8 illustrates a conventional form of business transaction in the event of settlement by remittance, and FIG. 9 is a flowchart for illustrating the flow. Incidentally, arrows with a dotted line, with a thin line and with a heavy line indicate flows of materials, information and money, respectively, in FIG. 8.

As shown in FIG. 8, the business transaction in the event of settlement by remittance is organized by a supplier 1 and a buyer 2 of merchandise, a shipping company 3 to transport the merchandise and an insurance company 4 to underwrite marine insurance policies.

As shown in FIG. 9, at first, a supplier 1 and a buyer 2 of merchandise conclude a contract (step S51). Then, the supplier 1 requests the shipping company 3 to transport merchandise purchased by the buyer 2, and delivers the merchandise to the shipping company 3 (step S52, S53). On the other hand, in the event the supplier I fails to deliver the merchandise to the shipping company 3, it results in non-fulfillment of the contract (step S52, S54). The shipping company 3 issues a Bill of Lading (e.g., mentioned as “B/L” hereinafter) which is a marketable security to prove the ownership of the merchandise, or a Sea Way Bill (e.g., mentioned as “SWB” hereinafter) which is a receipt of the merchandise and delivers the SWB to the supplier 1 (step S55, S56).

The supplier 1 forwards the B/L or the SWB delivered from the shipping company 3 to the buyer 2 (step S57). Thereafter, the buyer 2 submits the B/L or the SWB forwarded from the supplier 1 to the shipping company 3 (step S58). At that time, if the buyer 2 fails to pay a freight charge to the shipping company 3, then the shipping company 3 refuses to deliver the merchandise to the buyer 2 (step S59, S60). On the other hand, if the buyer 2 pays the freight to the shipping company 3, then the shipping company 3 delivers the merchandise to the buyer 2 (step S59, S61).

Here, as shown in FIG. 9(B), the buyer 2 is required to remit money for the merchandise to the supplier 1 (step S65). The time for remitting money is prescribed by a sales contract conducted between the supplier I and the buyer 2 of the merchandise. Usually, the time is prescribed when the supplier 1 ships the merchandise, as shown between step S56 and S57 in FIG. 9(A), or after the buyer 2 receives the merchandise as shown at the point after step S61 in FIG. 9(A).

Further, as shown in FIG. 9(C), the buyer 2 applies marine insurance to insure the merchandise and pays the premium to the insurance company 4 (step S66, S67). The insurance company 4 is required to issue and forward an insurance policy to the buyer 2 (step S68, S69). The time of signing up for the insurance contract may be prescribed voluntarily by the buyer 2, but usually is prescribed at the time before the supplier 1 ships the merchandise (i.e., before step S53 in the FIG. 9(A)).

FIG. 10 illustrates the business transaction in the event of conventional settlement by transaction drafts (D/P), and FIG. 11 is a flowchart for illustrating the flow of the settlement. Incidentally, arrows with a dotted line, with a thin line and with a heavy line indicate flows of materials, information and money, respectively, in FIG. 10.

As shown in FIG. 10, the business transaction in the event of settlement by transaction drafts is organized by a supplier 11 and a buyer 12 of merchandise, a shipping company 13 to transport the merchandise, an insurance company 14 to underwrite marine insurance policies, a financial institution 15 belonging to (e.g., chartered in) the country in which the supplier 11 is located and a financial institution 16 belonging to the country in which the buyer 12 is located.

As shown in FIG. 11, first the supplier 11 and the buyer 12 of merchandise conclude a sales contract (step S71). Then, the supplier 11 requests the shipping company 13 to transport merchandise purchased by the buyer 12, and delivers the merchandise to the shipping company 13 (step S72, S73). On the other hand, if the supplier 11 fails to deliver the merchandise to the shipping company 13, then non-fulfillment of the contract results (step S72, S74). The shipping company 13 issues and delivers a B/L to the supplier 11 (step S75, S76).

The supplier 11 prepares for a documentary bill of exchange to advise the buyer 12 to settle the payment (step S77), and submits the documentary bill of exchange with the BIL delivered from the shipping company 13 to the financial institution 15 belonging to the country in which the supplier 11 is located (step S78). Then, the financial institution 15 forwards the documentary bill of exchange and the B/L submitted by the supplier 11 to the financial institution 16 belonging to the country in which the buyer 12 is located (step S79). After the financial institution 16 receives the documentary bill of exchange and the B/L, the buyer 12 pays the price for the merchandise to the financial institution 16 (step S81). Then, the financial institution 16 delivers the B/L to the buyer 12 (step S82).

Thereafter, the buyer 12 submits the B/L delivered from the financial institution 16 to the shipping company 13 (step S83). At that time, if the buyer 12 fails to pay a freight charge to the shipping company 13, then the shipping company 13 refuses to deliver the merchandise to the buyer 12 (step S84, S85). On the other hand, if the buyer 12 pays the freight to the shipping company 13, then the shipping company 13 delivers the merchandise to the buyer 12 (step S84, S86).

Further, the financial institution 16 remits money paid for the merchandise to the financial institution 15 (step S87) after the delivery of the BIL (step S82). The financial institution 15 transfers the price for the merchandise remitted from the financial institution 16 to an account of the supplier 11(step S88).

At this time, the buyer 12 applies marine insurance to insure the merchandise and pays the premium to the insurance company 14, similarly as shown in FIG. 9(C). The insurance company 14 is required to issue and forward the insurance policy to the buyer 12. The time of signing up for the insurance contract may be prescribed voluntarily by the buyer 12, but usually is prescribed at the time before the supplier 11 ships the merchandise (i.e., before the step S73 in FIG. 11).

In the conventional business transaction, in the event of settlement by remittance as mentioned above, there is no condition to mechanically bind the timing when transferring the merchandise transaction rights and the timing when the buyer 2 remits money for merchandise to the supplier 1 (i.e., the timing for the price settlement). Therefore, the buyer 2 assumes a risk of non-delivery of the merchandise if the buyer 2 completes the payment of the price before the supplier 1 ships the merchandise (i.e., in the event of advance payment). Conversely, the supplier 1 assumes a risk of non payment (or payment in arrears)if the buyer 2 pays the price after receiving the merchandise (i.e., in the event of deferred payment).

Further, the buyer 2 spends much time and effort, for the payment of the freight to the shipping company 3 and the insurance premium to the insurance company 4 at each purchase of the merchandise. To solve this problem, the buyer 2 can adopt a method to pay a lump sum for the freight and the insurance premium of a certain time period. However, according to this method, the shipping company 3 and the insurance company 4 assume a risk of an outstanding payment.

On the other hand, in the event of a conventional settlement by transaction draft, the above-mentioned risk may be avoided, because the timing of transferring the merchandise transaction rights and the timing of the price settlement are typically concurrent. However, if that the buyer 2 finds some different type or flawed articles in the merchandise after receiving the delivery, a risk arises that the refund guarantee by the supplier 1 is not secured at all.

Furthermore, as a documentary bill of exchange and the B/L or the SWB are forwarded from one financial institution 15 to the other financial institution 16, events may arise such that the arrival of the above-mentioned documents lags behind the delivery of the merchandise. Such events result in a heavy delay of the documents and cause a problem that the buyer 2 may miss the sales timing of the merchandise. Similar problems arise in paying the freight or the insurance premium of the merchandise as the problem in above-mentioned business transaction in the event of settlement by remittance. Incidentally, similar problems arise not only in the business transactions under the FOB condition described above, but also business transactions under other terms of the trade terms.

### SUMMARY OF THE INVENTION

In view of the foregoing problems, drawbacks, and disadvantages of the conventional methods and systems, it is therefore an object of the present invention to provide a business transaction device, system, methods, information recording medium and program products by which prices of merchandise or of services associated with the merchandise can be exchanged safely and securely and the number of times and amounts of remittance between accounts can be reduced.

To solve the above-mentioned problems, in a first aspect of the present invention, a business transaction device for transacting merchandise includes a contract information recording portion for recording information of the contract concluded between a supplier and a buyer of merchandise, a bill storage portion for storing bills and/or certificates issued with respect to the requests for the services provided associated with respect to the fulfillment of the contracts, a first virtual account for receiving the fee classified by the contracts virtually, and a second virtual account for receiving virtually the fee classified by the supplier of the merchandise and the service provider.

The remittance for settlement which is assigned in advance based on the contract information recorded in the contract information recording portion from the buyer to a third virtual account is transferred to the first account at every contract as a virtual fund. The remittance is also transferred to the second virtual account allotted to each supplier of the merchandise and to each service provider, respectively.

The bills and/or certificates stored in the bill storage portion are returned to the service provider and/or delivered to the buyer and/or the supplier.

Preferably, the service preferably includes a transportation of the merchandise, and a bill issued with respect to the request of the transportation includes a delivery bill of the merchandise. In an exemplary embodiment, the service may include an insurance and/or guarantee which relate to fulfillment of the contract of the business transaction, and bills and/or certificates issued with respect to the request of the insurance and/or guarantee may include the insurance policies and/or the certificates which relate to fulfillment of the contract of the business transaction.

With the present invention, payments of, for example, the prices of merchandise, freight, an insurance premium, a security deposit, and the like, may be exchanged by providing some virtual accounts. The price settlement of the merchandise can be executed according to the contract concluded between the supplier and the buyer, and payment of freight, insurance premium and/or security deposit can be executed according to the agreements made between the buyer and a shipping company, an insurance company and/or a service provider in voluntary timing (e.g., at any time) between the beginning of the transportation and delivery of the merchandise, respectively. Thus, risks such as non-delivery of the merchandise, payment in arrears, non-recoverable payment, and the like, can be avoided.

The present disclosure relates to subject matter contained in Japanese Patent Application No. 12-237638, filed Aug. 1, 2000, which is expressly incorporated herein by reference in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is a block diagram for showing a business transaction system 100 of an embodiment of the present invention;

FIG. 2 is a first flowchart for showing a process of the business transaction according to the business transaction system 100 shown in FIG. 1;

FIG. 3 is a second flowchart for showing a process of the business transaction according to the business transaction system shown in FIG. 1;

FIG. 4 is a disposition sequence for showing a process of the business transaction according to the business transaction system shown in FIG. 1;

FIG. 5 illustrates a concrete example of contract information recorded in a contract information recording portion of the business transaction system shown in FIG. 1;

FIG. 6 illustrates the business transaction system shown in FIG. 1 in the event that a plurality of financial institutions are connected thereto;

Fig.7 illustrates a timing for transferring the merchandise transacting rights and timing for settlement of the price according to the present invention as compared to the conventional methods;

FIG. 8 illustrates an aspect of the business transaction in the event of a conventional settlement by remittance;

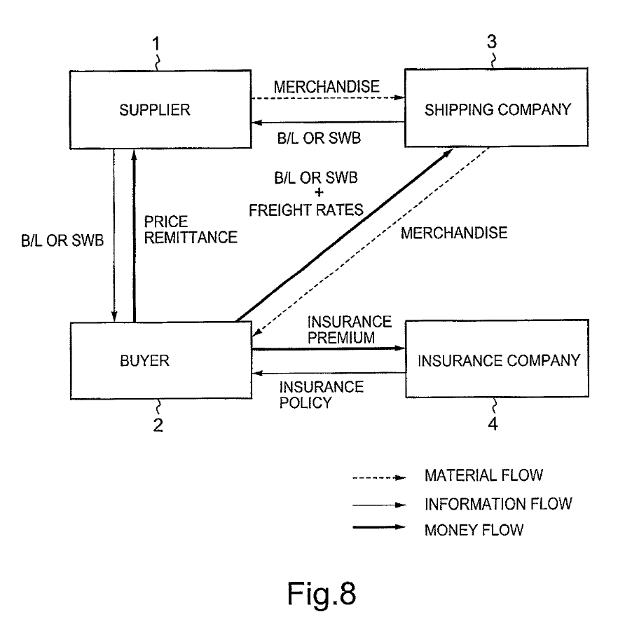

FIG. 9. is a flowchart for illustrating flows of another aspect of the business transaction in the event of the conventional settlement by remittance shown in FIG. 8;

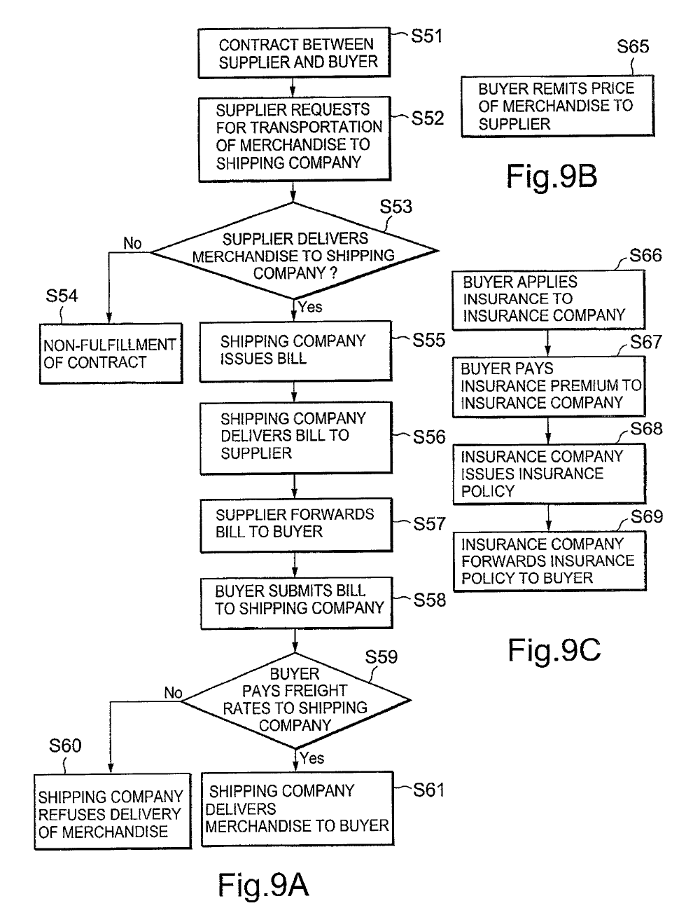

FIG. 10 illustrates another aspect of the business transaction in the event of a conventional settlement by transaction draft; and

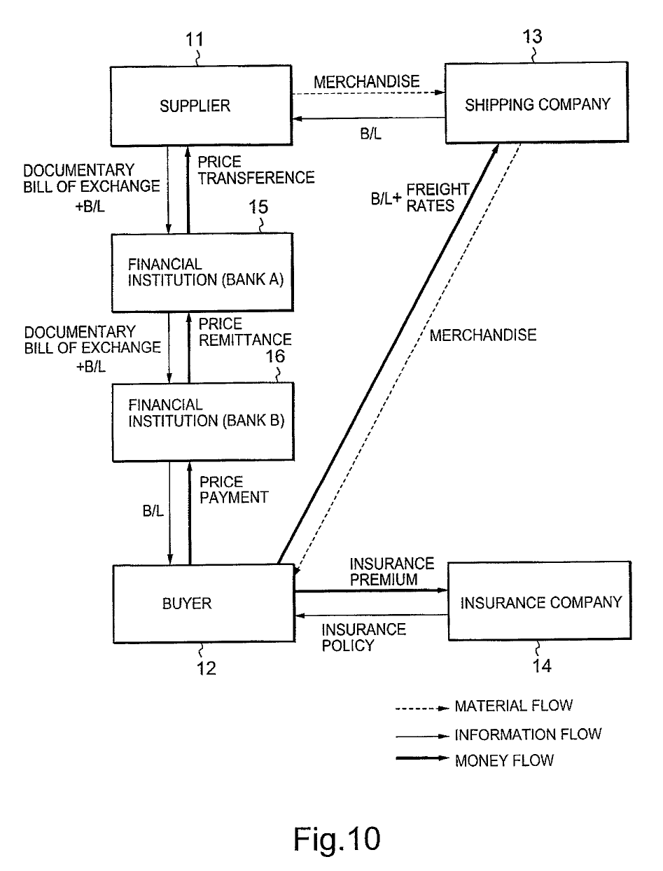

FIG. 11 is a flowchart for illustrating flows of another aspect of the business transaction in the event of the conventional settlement by transaction draft shown in FIG. 10.

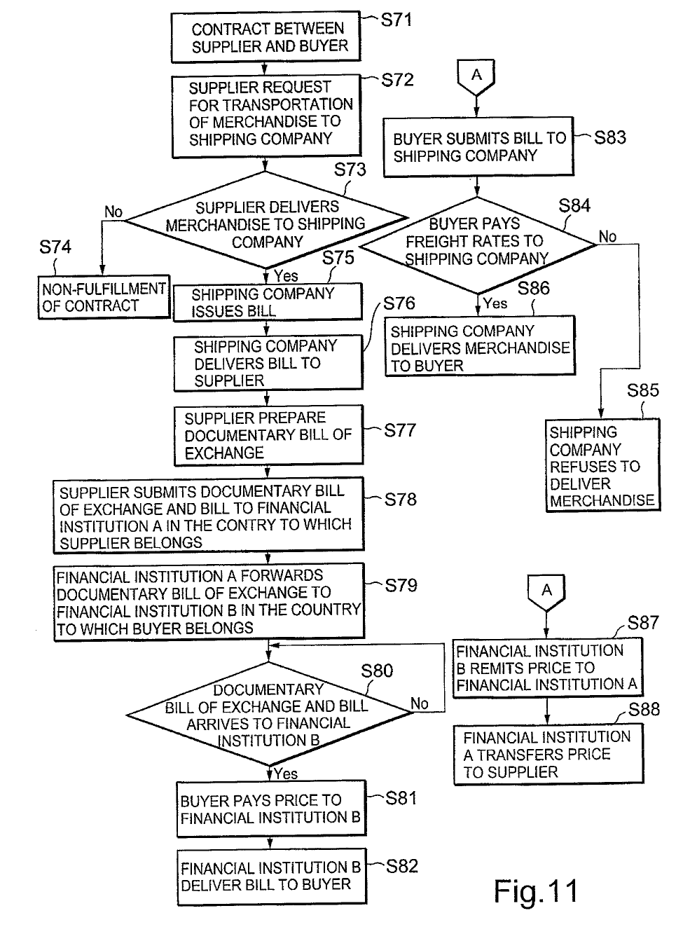

### DETAILED DESCRIPTION OF THE PREFERRED EMBODIMENTS

Referring now to the drawings, preferred embodiments of the present invention are described more particularly. Hereinafter, each number is corresponding to each member respectively in the accompanying drawings and some overlapping explanations are abbreviated. Incidentally, the embodiment of the present invention is effective for implementing the present invention. However, as would be known by one of ordinary skill in the art taking the present specification as a whole, the present invention is not intended to be limited to the specific embodiment described.

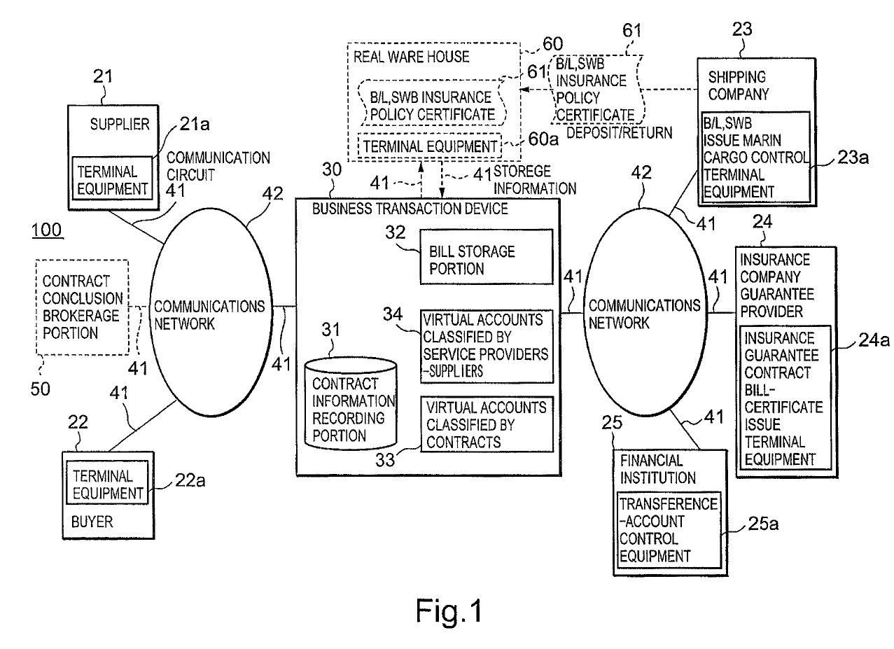

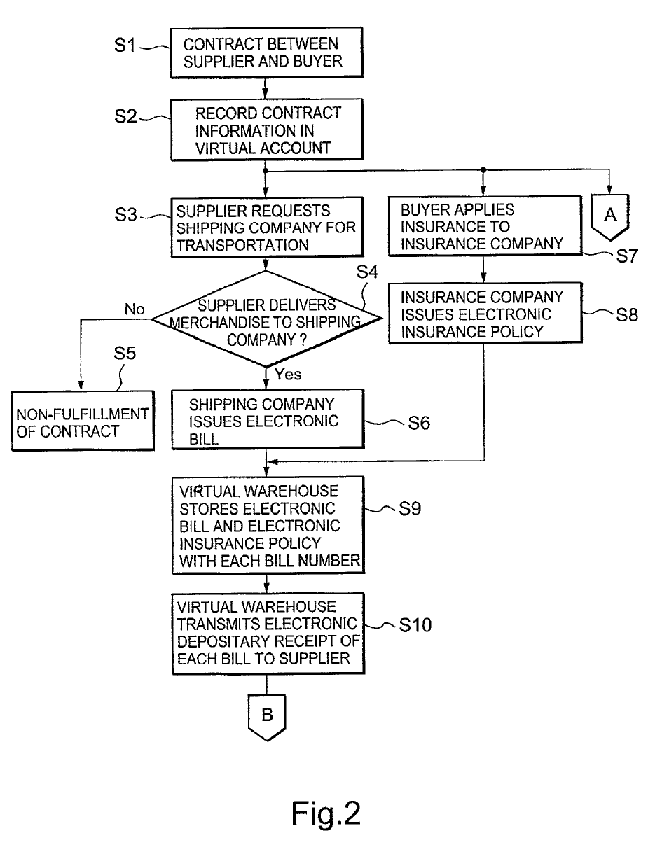

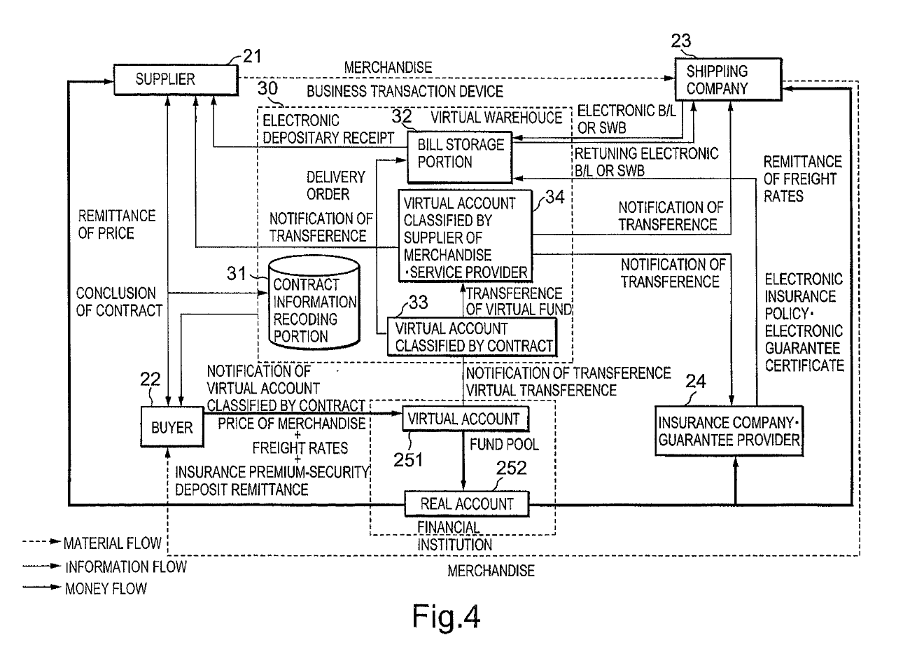

FIG. 1 schematically illustrates a business transaction system 100 which is one of the preferred embodiments of the present invention, and FIGS. 2-4 are flowcharts and a disposition sequence for showing the process of business transaction according to the business transaction system 100 shown in FIG. 1. Arrows with a dotted line, with a thin line and with a heavy line indicate flows of materials, information and money, respectively, in FIG. 4.

As shown in FIG. 1, the business transaction system 100 of the present invention includes a terminal equipment 21a of a supplier 21 of merchandise, a terminal equipment 22a of a buyer 22, a terminal equipment 23a of a shipping company 23, terminal equipment 24a of an insurance company and a guarantee provider 24, a terminal equipment 25a of a financial institution 25, and a business transaction device 30 connected to a communications network 42 via communications circuits 41.

Here, “computer equipment” including a system unit, a display portion and an input portion, is provided as the business transaction device 30 and each of the terminal equipments 21a, 22a, 23a, 24a and 25a on the side of the supplier 21, the buyer 22, the shipping company 23, the insurance company or the guarantee provider 24 and the financial institution 25, respectively. However, not only computers are included but also any kinds of equipment capable of being connected to the communications network 42. For example, telephones, television sets and the like are also acceptable for the terminal equipment 21 a and 22a for the supplier 21 and the buyer 22.

Further, not only an open network, such as the Internet and the like, but also closed networks such as a corporate intranet, are also acceptable as the communications network 42. Additionally, not only wire but also wireless communications (including digital broadcast) are acceptable. Further, the business transaction system is applicable to a business transaction without using the telecommunication network 42. Incidentally, when the party is simply mentioned as the supplier 21, the buyer 22, the shipping company 23, the insurance company or the guarantee provider 24, and the financial institution 25, it is understood that each of the parties conducts the business transaction using each of the terminal equipment 21a, 22a, 23a, 24a, and 25a.

As shown in FIG. 1, the business transaction device 30 includes a contract information recording portion 31, a bill storage portion 32, virtual accounts 33 (i.e., first virtual accounts) classified by contracts and virtual accounts 34 (i.e., second virtual accounts) classified by suppliers of merchandise and by service providers and provides a function as a virtual warehouse for installing various kinds of electronic data processed in each of the above-mentioned portions.

The contract information recording portion 31 records information of the contract concluded between the supplier 21 and the buyer 22 (e.g., information of the merchandise, terms of settlement, and the like).

The bill storage portion 32 stores various kinds of bills issued with respect to services provided associated with the merchandise (e.g., electronic bills) and/or certificates issued with respect to the requests of insurance and/or guarantee, and the like which relate to transportation and fulfillment of the business transaction contract (e.g., for example, B/L, SWB, marine cargo insurance policies, delayed damage insurance policies, defect liability insurance policies, and the like issued in the event of transportation by ship), and guarantee insurance policies and/or guarantee certificates associated with the fulfillment of the contract by the supplier 21 and with the payment by the buyer 22. Payment by each contract is virtually transferred to the first virtual accounts 33. Payment classified by the above-mentioned service providers (i.e., the shipping company 23 and the insurance company or the guarantee provider 24) is virtually transferred to the second virtual accounts 34.

Incidentally, portions illustrated by dotted lines in FIG. 1 are mechanisms used as required. That is, the contract conclusion brokerage portion 50, which is connected to communications network 42 via the communications circuit 41, mediates the fulfillment of the contract between the merchandise supplier 21 and the buyer 22 and transmits the contract information to the business transaction device 30 to record the information in the contract information recording portion 31 therein. Accordingly, the business transaction may be performed smoothly by providing the contract conclusion brokerage portion 50.

Further, when it is required to issue a B/L or a SWB, insurance policies and/or certificates, and the like of, in paper form (e.g., “hard-copy”) for the convenience of institutions or other regulations, a real warehouse 60 for storing the above-mentioned paper bills and certificates 61 is provided outside of the communications network 42 in addition to the business transaction device 30 (which functions as a virtual warehouse). Further, corresponding to depositing, returning and forwarding the above-mentioned bills and certificates 61 in paper form with respect to the real warehouse 60, storage information and delivery order(s) are exchanged between a terminal equipment 60a provided in the real warehouse 60 and the bill storage portion 32 in the business transaction device 30 via the communications circuit 41.

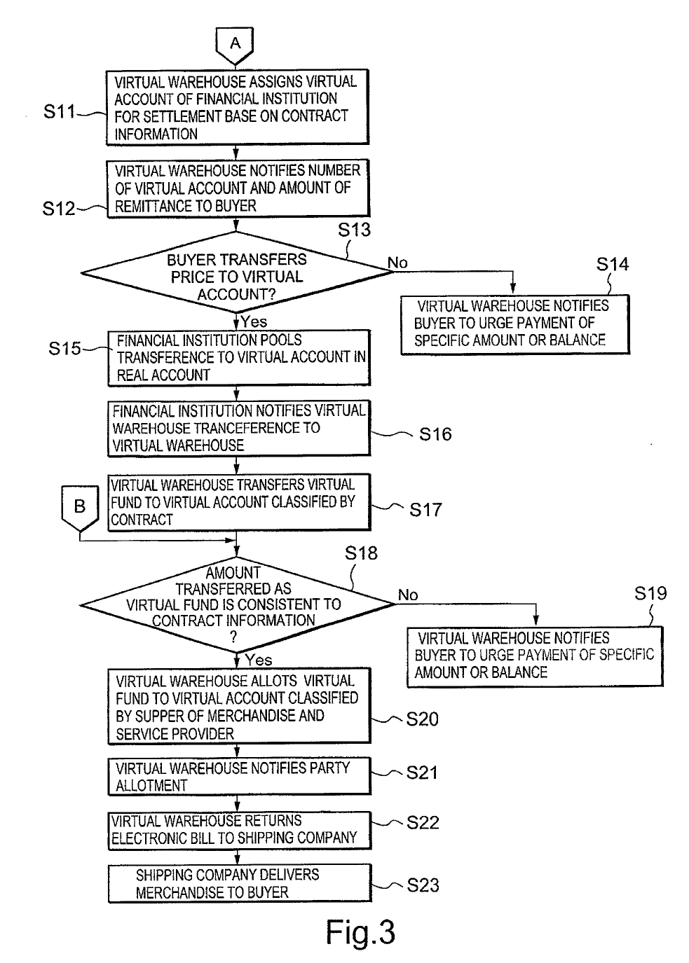

Hereinafter, a process of a business transaction according to the business transaction system 100 having the above construction is described referring to the flowcharts of FIGS. 2 and 3 and the disposition sequence of FIG. 4.

First, the supplier 21 and the buyer 22 conclude a sales contract via the communications network 42(step S1), and the contract information is recorded in the contract information recording portion 31 (step S2). By this time, the business transaction device 30 provides virtual accounts (i.e., third virtual accounts) 251 classified by each contract open in the financial institution 25 and a real account 252 for collecting the virtual accounts 251 in advance.

Then, the supplier 21 requests the shipping company 23 for transportation of the merchandise purchased by the buyer 22 and delivers the merchandise to the shipping company 23 (steps S3, S4). In the event the supplier 21 fails to deliver the merchandise to the shipping company 23, non-fulfillment of the contract obligation occurs(steps S3, S5). The shipping company 23 issues a B/L or a SWB electronically (step S6), and stores the electronic bill with a bill number in the bill storage portion 32.

Meanwhile, after step S2, the buyer 22 applies for marine insurance, to cover the merchandise, from the insurance company and guarantee provider 24 paralleling the request of transportation of the merchandise (step S7). Then, the insurance company and guarantee provider 24 issue an insurance policy electronically (step S8), and store the electronic insurance policy with the bill number in the bill storage portion 32 (step 9).

Then, business transaction device 30 issues a depositary receipt with respect to the electronic B/L or SWB which is stored in the bill storage portion 32, and transmits the receipt to the supplier 21(step 10). The validity of the depositary receipt expires when the remittance from the buyer 22 is confirmed. Further, issuance of the depositary receipt may be omitted with the consent of the supplier 21.

Further, in parallel with the processing of the electronic bill, the business transaction device 30 processes the steps mentioned below.

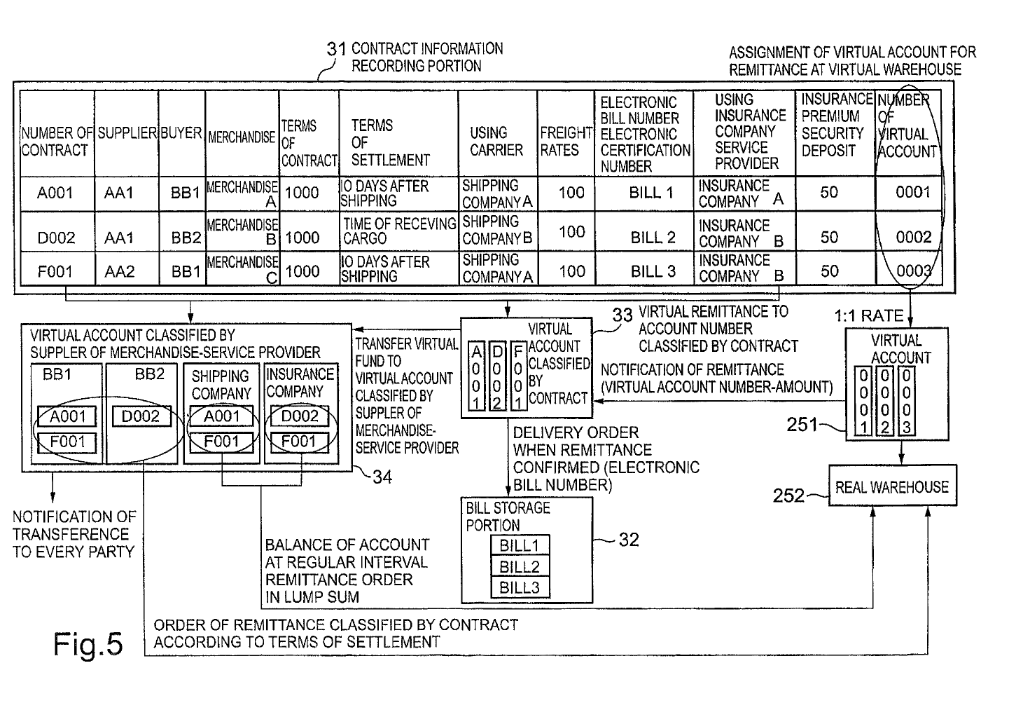

That is, referring to FIG. 5 illustrating a concrete example of the contract information recorded in the contract information recording portion 32, the process is described as follows. Data about contract numbers, except for the virtual account numbers, the buyer, the supplier, merchandise, prices, terms of settlement, using carrier, freight, electronic bill number and/or electronic certificate number, using insurance company and/or service provider and insurance premium and/or guarantee deposit, are written in as the contract information.

First, turning to FIG. 3, the virtual account numbers (e.g., 0001┘ ┌0002┘ ┌0003┘) are assigned to each of the third virtual accounts 251 (step S11) for settlement of the pertinent contract and written into the contract information. The number of the third virtual accounts 251 and the amount of remittance transferred by the buyer 22 (i.e., a sum total of the price of the merchandise, the freight and the insurance premium) are notified to the buyer 22 (step S12).

Thereafter, if the buyer 22 fails to remit a specified amount to the designated third virtual account 251, the business transaction device 30 notifies the buyer 22 to urge the remittance of the fixed amount or the shortage (steps S13 and S14).

On the other hand, when the buyer 22 remits the specific amount to the designated third virtual account 251 (step S13), the financial institution 25 pools the money transferred to the third virtual account 251 in the real account 252 temporarily, and concurrently transmits notifications to the business transaction device 30 that the money was transferred to the pertinent third virtual account 251 (steps S15, S16). Then, the business transaction device 30 refers to the contract numbers (e.g., ┌A001┘, ┌D002┘, ┌F001┘), and transfers a virtual fund from the pertinent third virtual account 251 to the first virtual account 33 corresponding to the respective contracts (step S17). Thereafter, the business transaction device 30 checks whether the amount of the virtual And transferred to the first virtual account is consistent with the amount of the contract information recorded in the contract information recording portion 31 (step S18). If the above-mentioned amounts are inconsistent with each other, then the business transaction device 30 notifies the buyer 22 to urge the remittance of the fixed amount or the shortage (step S19).

On the other hand, when the amount of the virtual fund transferred to the first virtual account 33 is consistent with the contract information recorded in the contract information recording portion 31, the business transaction device 30 gives the bill storage portion 32 an order to deliver the electronic B/L or SWB with electronic bill numbers ┌1┘, ┌2┘, ┌3┘ which are pertinent to the contract numbers ┌A001┘, ┌D002┘, ┌F001┘. Simultaneously, the business transaction device 30 allots the virtual fund in the first virtual accounts 33 to the second virtual accounts 34, for example, contract numbers ┌A001┘ and ┌F001┘ are allotted to the supplier ┌BB1┘, a contract number ┌D002┘ is allotted to the supplier ┌BB2┘, contract numbers ┌A001┘ and ┌F001┘ are allotted to the shipping company ┌A┘ and contract numbers ┌D001┘ and ┌F001┘ are allotted to the insurance company ┌B┘ (step S20).

Further, the business transaction device 30 notifies the supplier 21, the shipping company 23 and the insurance company or the guarantee provider 24 that the allotment of the virtual fund to the second virtual account 34 is settled. Then, the electronic B/L or SWB which are delivered by an order of the business transaction device 30 are returned to the shipping company 23 or transmitted to the buyer 22 (step S22). Thus, so-called “merchandise transaction rights” are transferred to the buyer 22, and the shipping company 23 delivers the merchandise to the buyer 22 (step S23).

Further, the business transaction device 30 may be connected to a plurality of shipping companies 23, insurance companies or guarantee providers 24, financial institutions 25, and the like. Particularly, if a plurality of insurance companies 25 are connected, then it is possible to compress the number of remittances between the financial institutions, to minimize the price, and to reduce the costs for remittance significantly by switching the payment of the price associated with each transaction (balance settlement) based on the information of the business transaction device 30.

For example, assume two financial institutions A and B, exist, and that the financial institution A has a daily transaction with a buyer A and a supplier B and that the financial institution B has a daily transaction with a buyer B and a supplier A. Conventionally, when the buyer A conducts a payment associated with the transaction with supplier A, remittances are conducted from the financial institution A through the financial institution B. When the buyer B conducts the payment associated with the transaction with supplier B, remittances are conducted from the financial institution B through the financial institution A.

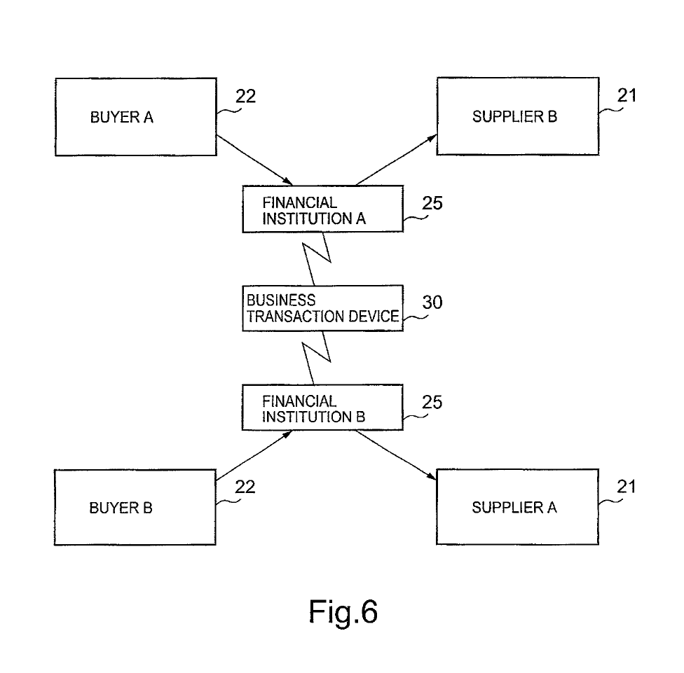

On the other hand, as shown in FIG. 6, when the financial institutions A and B are connected to the business transaction device 30, real accounts A′ and B′ of the business transaction device 30 are opened in the financial institutions A and B in advance. As such, payment from the buyer A to the supplier A is transferred to the real account A′ and payment from the buyer B to the supplier B is transferred to the real account B′, in the same manner. Then, the business transaction device 30 withdraws the transference from the buyer A from the real account A′ to earmark it for the payment to the supplier B, and withdraws the transference from the buyer B and from the real account B′ to earmark it for the payment to the supplier A similarly. Accordingly, the number of remittances may be reduced between the financial institutions A and B, to minimize the price and to reduce significantly the costs for remittance. Incidentally, the business transaction device 30 manages the balance of the real accounts A′ and B′ at all times. If an excess or a deficiency is found in the amount to be pooled, then the business transaction device 30 conducts the remittance between the financial institutions A and B.

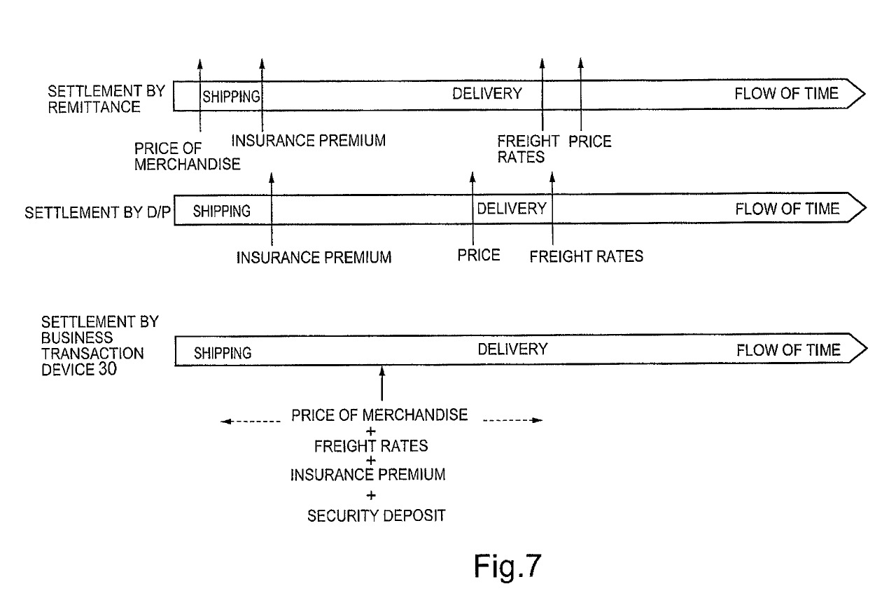

As shown in FIG. 7, in a business transaction for the conventional settlement by remittance, there is no condition to bind timings for transferring the merchandise transaction rights and for price settlement mechanically. Thus, for an advance payment, a risk arises that the supplier 1 fails to deliver the merchandise. Moreover, in the event of a deferred payment, another risk arises that the buyer 2 obtains the merchandise only by paying a freight charge and without actually paying the price of the merchandise. Further, in a business transaction in the event of the conventional settlement by remittance and settlement by transaction draft, a risk arises that the buyer 2 applies for insurance without paying for the premium except for when an accident occurs.

However, according to the business transaction system 100 of the present invention, settlement of the price can be conducted according to the contract between the supplier 21 and the buyer 22. Further, payment of freight or an insurance premium can be conducted according to the agreements between the buyer 22 and the shipping company 23, or between the buyer 22 and the insurance company or guarantee provider 24. That is, the business transaction device 30 of the present invention orders the real account 252 (for settlement transferred corresponding to the remittance by the buyer 22 with respect to the third virtual account 251) to remit to the buyer 22, the shipping company 23, and the insurance company or guarantee provider 24. Additionally, with the invention, the freight charge or insurance premium for more than one contract can be remitted once at regular intervals.

Therefore, the timing of remittance by the buyer 22 and the timing of the payment to all the parties need not be concurrent. Accordingly, the conventional risks can be avoided and flexible and rational processing can be implemented corresponding to the transaction requirements. Additionally, a lump sum payment and remittance of the prices, freight and insurance premiums can be made, thereby reducing costs for documentation, and the like. Further, processing speed can be accelerated significantly by implementing the process electronically. Moreover, documents, such as an insurance policy, which are required only if an accident occurs, can be issued on demand, and costs for preparing and transmitting documents are reduced. As would be clearly recognized by one of ordinary skill in the art taking the present specification as a whole, the present invention is advantageous not only for business transactions under FOB conditions, as described above, but also for business transactions under other conditions of trade.

Further, the inventive business transaction technology described above can be executed by being installed in information recording media such as CD-ROM, magnetic disk/tape, and the like, as well as delivered as program products via a network.

As clear from the description above, with the unique and unobvious features of the present invention, the charges for services provided associated with merchandise or fulfillment of the merchandise transaction contract can be exchanged safely, because the price settlement of the merchandise is conducted according to a contract between a supplier and a buyer. Further, payment of the prices of the services is conducted according to an agreement between the buyer and a service provider.

Further, lump-sum payment and remittance of money, freights and insurance premiums can be made, thereby reducing costs for remittance or documentation, and the like. Additionally, the number of times for remittance can be reduced, thereby to minimize the prices, and the like.

While the invention has been described in terms of several preferred embodiments, those skilled in the art will recognize that the invention can be practiced with modification within the spirit and scope of the appended claims.

What is claimed is:

1. A business transaction device for transacting merchandise, comprising:
a contract information recording portion for recording information of contracts concluded between suppliers and buyers of said merchandise;
a bill storage portion for storing at least one of bills and certificates issued with respect to requests for services provided associated with fulfillment of said contracts;
first virtual accounts for receiving virtually a fee classified by said contracts; and
second virtual accounts for receiving virtually a fee classified by a supplier of the merchandise and service providers; and
third virtual accounts, for holding virtual finds of said buyer, wherein a remittance, which is assigned for settlement in advance based on said contract information recorded in said contract information recording portion with respect to third virtual accounts from said buyer, is transferred to said first accounts at each contract as a virtual fund.

2. A business transaction device for transacting merchandise as claimed in claim 1, wherein said remittance is further transferred to said second virtual accounts allotted to each of said supplier and said service provider, respectively, and
wherein said at least one of the bills and the certificates stored in said bill storage portion is at least one of returned to said service provider and forwarded to at least one of the buyer and said supplier.

3. A business transaction device for transacting merchandise, comprising:
a contract information recording portion for recording information of contracts concluded between suppliers and buyers of merchandise;
a bill storage portion for storing at least one of bills and certificates issued with respect to requests for services provided associated with respect to fulfillment of said contracts, and for issuing depositary receipts with respect to the at least one of the bills and certificates to at least one of said suppliers, said buyers, and said service provider;
a first virtual account for receiving virtually a fee of each of said contracts;
a second virtual accounts for receiving virtually a fee classified by said supplier of the merchandise and each said service provider; and
third virtual accounts for holding virtual funds of said buyer,
wherein a number of the third virtual accounts, which are assigned for settlement in advance based on said contract information recorded in said contract information recording portion and an amount of remittance as a compensation for said business transaction to the third virtual accounts, are notified to said buyer.

4. The device of claim 3, wherein remittance from said buyer with respect to said third virtual accounts is transferred to said first accounts at every contract as virtual funds, the amount of remittance of said virtual funds is allotted further to each said supplier of the merchandise and said service provider in said second virtual accounts in the event the amount of remittance of said virtual fund is consistent with said contract information, and
wherein said at least one of the bills and certificates stored in said bill storage portion are at least one of returned to said service provider and forwarded to at least one of said buyer and said supplier, and said supplier and said service provider are notified that said virtual fund has been allotted to said second virtual account.

5. The business transaction device for transacting merchandise as claimed in claim 1, wherein said service comprises a transportation of said merchandise, and a bill issued with respect to the request of the transportation comprises a bill of delivery of said merchandise.

6. The business transaction device for transacting merchandise as claimed in claim 3, wherein said service comprises a transportation of said merchandise, and a bill issued with respect to the transportation request comprises a bill of delivery of said merchandise.

7. The business transaction device for transacting merchandise as claimed in claim 1, wherein said service comprises at least one of an insurance and a guarantee which relate to fulfillment of the contract of said business transaction, and
wherein said at least one of the bills and the certificates issued with respect to at least one of the request of the insurance and the guarantee comprise at least one of the insurance policies and guarantee certificates which relate to fulfillment of the contract for said business transaction.

8. The business transaction device for transacting merchandise as claimed in claim 3, wherein said service comprises at least one of an insurance and a guarantee which relate to fulfillment of the contract of said business transaction, and
wherein said at least one of the bills and the certificates issued with respect to at least one of the request of the insurance and the guarantee comprise at least one of the insurance policies and guarantee certificates which relate to fulfillment of the contract for said business transaction.

9. The business transaction device for transacting merchandise as claimed in claim 1, wherein said at least one of the bills and the certificates comprise at least one of electronic bills and certificates.

10. The business transaction device for transacting merchandise as claimed in claim 3, wherein said at least one of the bills and the certificates comprise at least one of electronic bills and certificates.

11. The business transaction device for transacting merchandise as claimed in claim 1, further comprising a contract conclusion brokerage portion for mediating the fulfillment of the contract between said supplier and said buyer.

12. The business transaction device for transacting merchandise as claimed in claim 3, further comprising a contract conclusion brokerage portion for mediating the fulfillment of the contract between said supplier and said buyer.

13. The business transaction device for transacting merchandise as claimed in claim 1, wherein the real account pools transferences to said third virtual accounts, and a plurality of real accounts to which prices are transferred and paid with respect to predetermined ones of said buyer and supplier are opened, and
wherein the transference by said buyer corresponding to said real accounts are earmarked for payments of a supplier other than one of said supplier and a service provider other than said service provider who are not corresponding to one of the pertinent real accounts and the payment of at least one of a supplier and a service provider under a contract other than said contract.

14. The business transaction device for transacting merchandise as claimed in claim 3, wherein the real account pools transferences to said third virtual accounts, and a plurality of real accounts to which prices are transferred and paid with respect to predetermined ones of said buyer and supplier are opened, and
wherein the transference by said buyer corresponding to said real accounts are earmarked for payments of a supplier other than one of said supplier and a service provider other than said service provider who are not corresponding to one of the pertinent real accounts and the payment of at least one of a supplier and a service provider under a contract other than said contract.

15. A business transaction system, comprising:
a business transaction device as claimed in claim 1; and
terminal equipment of said supplier and buyer of the merchandise being connected to said business transaction device by a communications circuit,
wherein business transactions are conducted via said terminal equipment operated by said supplier, said buyer of the merchandise, and said business transaction device.

16. A business transaction system, comprising:
a business transaction device as claimed in claim 3; and
terminal equipment of said supplier and buyer of the merchandise being connected to said business transaction device by a communications circuit,
wherein business transactions are conducted via said terminal equipment operated by said supplier, said buyer of the merchandise, and said business transaction device.

17. A business transaction system comprising:
a business transaction device as claimed in claim 1; and
terminal equipment of said service provider being connected to said business transaction device by a communications circuit,
wherein business transactions are conducted via said terminal equipment operated by said service provider and said business transaction device.

18. A business transaction system, comprising:
a business transaction device as claimed in claim 3; and
terminal equipment of said service provider being connected to said business transaction device by a communications circuit,
wherein business transactions are conducted via said terminal equipment operated by said service provider and said business transaction device.

19. A business transaction system, comprising:
a business transaction device as claimed in claim 1; and
terminal equipment of said supplier, said buyer of the merchandise, and said service provider being connected to said business transaction device by a communications circuit,
wherein business transactions are conducted via said business transaction device and said terminal equipment operated by said supplier, said buyer of the merchandise, and said service provider.

20. A business transaction system, comprising:
a business transaction device as claimed in claim 3; and
terminal equipment of said supplier, said buyer of the merchandise, and said service provider being connected to said business transaction device by a communications circuit,
wherein business transactions are conducted via said business transaction device and said terminal equipment operated by said supplier, said buyer of the merchandise, and said service provider.

21. A method of business transaction for transacting merchandise, comprising:
recording information of a contract conducted between a supplier and a buyer of merchandise;
storing at least one of bills and certificates issued with respect to requests of services provided associated with fulfillment of said contract;
providing first virtual accounts in which prices of each of a plurality of contracts are transferred and second virtual accounts in which prices of each of said supplier and said service provider are provided, third virtual accounts being assigned for settlement based on said contract information;
in the event of receiving a notification of remittance by said buyer to said third virtual account, a pertinent remittance is classified by contracts and transferred as virtual funds to said first virtual accounts, when the amount of said virtual finds transferred is consistent with said contract information, said virtual funds are allotted to said second virtual accounts and classified by said suppliers and said service providers and said at least one of said bills and certificates are at least one of returned to said service provider and are forwarded to at least one of said buyer and said supplier.

22. A method of business transaction for transacting merchandise, comprising:
recording information of a contract conducted between a supplier and a buyer of merchandise;
storing at least one of bills and certificates issued with respect to requests of services provided associated with fulfillment of said contract;
issuing depositary receipts with respect to the at least one of bills and certificates to at least one of said supplier, said buyer, and said service provider;
providing first virtual accounts in which prices of each of a plurality of contracts are transferred and second virtual accounts in which prices classified by said suppliers and said service providers are provided;
assigning third virtual accounts for settlement based on said contract information; and
notifying a number of said third virtual accounts and an amount of a price of said merchandise remitted to said third virtual accounts, to said buyer, when said buyer receives a notification of remittances to said third virtual accounts,
wherein pertinent remittances are classified by contracts and transferred as virtual funds to said first virtual accounts, when the amount of said virtual funds transferred are consistent with said contract information, said virtual funds are allotted to said second virtual accounts and classified by said suppliers and said service provider, said at least one of the bills and the certificates are at least one of returned to said service provider and are forwarded to at least one of said buyer and said supplier, and said supplier and said service provider are notified that said virtual funds with respect to said second virtual accounts are allotted.

23. The method of business transaction as claimed in claim 21, wherein said service comprises a transportation of said merchandise, and a bill issued with respect to a request of the transportation comprises a bill of delivery of said merchandise.

24. The method of business transaction as claimed in claim 22, wherein said service comprises a transportation of said merchandise, and a bill issued with respect to a request of the transportation comprises a bill of delivery of said merchandise.

25. The method of business transaction as claimed in claim 21, wherein said service comprises at least one of an insurance and a guarantee which relates to fulfillment of said contract of said business transaction, and
wherein the at least one of bills and certificates issued with respect to the request of the at least one of the insurance and the guarantee comprise at least one of the insurance policies and guarantee certificates which relate to fulfillment of said contract of said business transaction.

26. The method of business transaction as claimed in claim 22, wherein said service comprises at least one of a insurance and a guarantee which relates to fulfillment of said contract of said business transaction,
and wherein the at least one of bills and certificates issued with respect to a request of the at least one of the insurance and the guarantee comprise at least one of the insurance policies and guarantee certificates which relate to fulfillment of contract of said business transaction.

27. The method of business transaction as claimed in claim 21, wherein said at least one of the bills and the certificates comprise at least one of electronic bills and certificates.

28. The method of business transaction as claimed in claim 22, wherein said at least one of the bills and the certificates comprise at least one of electronic bills and certificates.

29. The method of business transaction as claimed in claim 21, wherein the real account pools the money for transferring to said third virtual accounts, a plurality of real accounts to which prices are transferred and paid with respect to a predetermined one of said buyer and said supplier are opened and the transference by said buyer corresponding to said real accounts are earmarked for the payments of at least one of a supplier other than said supplier and a service provider other than said service provider who are not corresponding to at least one of the pertinent real accounts and the payment of at least one of a supplier and a service provider under a contract other than said contract.

30. The method of business transaction as claimed in claim 22, wherein the real account pools the money for transferring to said third virtual accounts, a plurality of real accounts to which prices are transferred and paid with respect to a predetermined one of said buyer and said supplier are opened and the transference by said buyer corresponding to said real accounts are earmarked for the payments of at least one of a supplier other than said supplier and a service provider other than said service provider who are not corresponding to at least one of the pertinent real accounts and the payment of at least one of a supplier and a service provider under a contract other than said contract.

31. An information recording medium for installing a program for performing a method of transacting merchandise processing, the method comprising:
recording information of a contract conducted between a supplier and a buyer of merchandise;
storing at least one of bills and certificates issued with respect to requests for services provided associated with fulfillment of said contract;
providing first virtual accounts in which prices classified by said contract are transferred and second virtual accounts in which prices classified by suppliers and service providers are provided;
assigning a third virtual account for settlement based on said contract information;
transferring a pertinent remittance classified by each contract as virtual funds to said first virtual accounts when said buyer receives a notification of remittance to said third virtual account;
allotting said transferred virtual funds to said second virtual account and classifying by said suppliers and said service providers when an amount of said virtual funds is consistent with said contract information; and
at least one of returning said at least one of the bills and the certificates to said service provider and forwarding the at least one of the bills and the certificates to the at least one of said buyer and said supplier.

32. An information recording medium for installing a program for performing a method of transacting merchandise processing, the method comprising:
recording information of a contract conducted between a supplier and a buyer of merchandise;
storing at least one of bills and certificates issued with respect to requests for services provided associated with fulfillment of said contract;
issuing depositary receipts with respect to the at least one of the bills and the certificates to at least one of said supplier, said buyer, and a service provider;
providing first virtual accounts in which prices classified by said contract are transferred and said second virtual accounts in which prices classified by said supplier and said service provider are provided;
assigning third virtual accounts for settlement based on said contract information;
notifying said buyer of a number of said third virtual accounts and said amount of remittance to said third virtual account;
classifying pertinent remittances by each contract and transferring as a virtual fund to said first virtual accounts when said buyer receives a notification of remittance to said third virtual accounts;
allotting said transferred virtual funds to said second virtual account and classified by said supplier and each said service provider when the amount of said virtual fund is consistent with said contract information; and
at least one of returning said at least one of the bills and the certificates to said service provider, and forwarding the at least one of the bills and the certificates to the at least one of said buyer and said supplier; and
notifying said supplier and said service provider that said virtual funds with respect to said second virtual accounts are allotted.

33. The information recording medium as claimed in claim 31, wherein said service comprises a transportation of said merchandise, and a bill issued with respect to a request for the transportation comprises a bill of delivery of said merchandise.

34. The information recording medium as claimed in claim 32, wherein said service comprises a transportation of said merchandise, and a bill issued with respect to a request for the transportation comprises a bill of delivery of said merchandise.

35. The information recording medium as claimed in claim 31, wherein said service comprises at least one of an insurance and a guarantee which relates to fulfillment of said contract of said business transaction, and
wherein said at least one of the bills and the certificates issued with respect to the requests for the at least one of the insurance and the guarantee comprise at least one of the insurance policies and the guarantee certificates which relate to fulfillment of said contract of said business transaction.

36. The information recording medium as claimed in claim 32, wherein said service comprises at least one of an insurance and a guarantee which relates to fulfillment of said contract of said business transaction, and
wherein said at least one of the bills and the certificates issued with respect to the requests for the at least one of the insurance and the guarantee comprise at least one of the insurance policies and the guarantee certificates which relate to fulfillment of said contract of said business transaction.

37. The information recording medium as claimed in claim 31, wherein said at least one of the bills and certificates comprise at least one of electronic bills and certificates.

38. The information recording medium as claimed in claim 32, wherein said at least one of the bills and certificates comprise at least one of electronic bills and certificates.

39. The information recording medium as claimed in claim 31, wherein said method further comprises:
pooling, by a real account, the money for transferring to said third virtual accounts, said pooling comprising:
opening a plurality of real accounts to which prices are transferred and paid with respect to a predetermined one of said buyer and said supplier;
at least one of earmarking a transference from said buyer corresponding to said real accounts for payments of at least one of a supplier other than said supplier and a service provider other than said service provider who are not corresponding to the pertinent real account, and the payment of at least one of a supplier and a service provider under a contract other than said contract.

40. The information recording medium as claimed in claim 32, wherein said method further comprises:
pooling, by a real account, the money for transferring to said third virtual accounts, said pooling comprising:
opening a plurality of real accounts to which prices are transferred and paid with respect to a predetermined one of said buyer and said supplier;
at least one of earmarking a transference from said buyer corresponding to said real accounts for payments of at least one of a supplier other than said supplier and a service provider other than said service provider who are not corresponding to the pertinent real account, and the payment of at least one of a supplier and a service provider under a contract other than said contract.

41. A program product for executing means for:
recording information of a contract conducted between a supplier and a buyer of merchandise;
storing at least one of bills and certificates issued with respect to requests for services provided associated with fulfillment of said contract;
providing a first virtual account in which prices classified by said contract are transferred and a second virtual account in which prices classified by said supplier and said service provider are provided;
assigning a third virtual account for settlement based on said contract information;
classifying pertinent remittances by each said contract and transferring as a virtual fund to said first virtual account when said buyer receives a notification of remittance to said third virtual account; and
allotting said transferred virtual funds to said second virtual account and classified by said suppliers and said service providers when an amount of said virtual funds is consistent with said contract information and at least one of returning said at least one of the bills and the certificates to said service provider and forwarding the at least one of the bills and the certificates to at least one of said buyer and said supplier.

42. A program product for executing means for:
recording information of a contract conducted between a supplier and a buyer of merchandise;
storing at least one of bills and certificates issued with respect to requests for services provided associated with fulfillment of said contract;
issuing depositary receipts with respect to the at least one of bills and certificates to at least one of said supplier, said buyer, and a said service provider;
providing a first virtual account in which prices classified by said contracts are transferred and a second virtual account in which prices classified by suppliers and service providers are provided;
assigning a third virtual account for settlement based on said contract information;
notifying said buyer of a number of said third virtual account and said amount of remittances to said third virtual account;
classifying pertinent remittances by each said contract and transferring as virtual funds to said first virtual account when said buyer receives a notification of remittance to said third virtual account;
allotting said transferred virtual funds to said second virtual account and classifying in each of said supplier and each of said service provider when the amount of said virtual fund is consistent with said contract information; and
at least one of returning said at least one of the bills and the certificates to said service provider and forwarding the at least one of the bills and the certificates to the at least one of said buyer and said supplier, and notifying said supplier and said service provider that said virtual funds with respect to said second virtual accounts are allotted.

43. The program product as claimed in claim 41, wherein said service comprises a transportation of said merchandise, and a bill issued with respect to a request of the transportation comprises a bill of delivery of said merchandise.

44. The program product as claimed in claim 42, wherein said service comprises a transportation of said merchandise, and a bill issued with respect to a request of the transportation comprises a bill of delivery of said merchandise.

45. The program product as claimed in claim 41, wherein said service comprises at least one of insurance and a guarantee which relate to fulfillment of said contract of said business transaction, and
wherein said at least one of the bills and the certificates issued with respect to the requests for the at least one of the insurance and the guarantee comprise the insurance policies and guarantee certificates which relate to fulfillment of said contract of said business transaction.

46. The program product as claimed in claim 42, wherein said service comprises at least one of insurance and a guarantee which relate to fulfillment of said contract of said business transaction, and
wherein said at least one of the bills and the certificates issued with respect to the requests for the at least one of the insurance and the guarantee comprise the insurance policies and guarantee certificates which relate to fulfillment of said contract of said business transaction.

47. The program product as claimed in claim 41, wherein said at least one of the bills and the certificates comprise at least one of electronic bills and certificates.

48. The program product as claimed in claim 42, wherein said at least one of the bills and the certificates comprise at least one of electronic bills and certificates.

49. The program product as claimed in claim 41, wherein a real account pools the money for transferring to said third virtual account, said transferring comprising:
opening a plurality of real accounts to which prices are transferred and paid with respect to predetermined ones of said buyer and said supplier; and
earmarking the transference from said buyer corresponding to said real accounts for at least one of the payments of a supplier other than one of said supplier and a service provider other than said service provider who are not corresponding to the pertinent real account and the payment of at least one of a supplier and a service provider under a contract other than said contract.

50. The program product as claimed in claim 42, wherein a real account pools the money for transferring to said third virtual account, said transferring comprising:
opening a plurality of real accounts to which prices are transferred and paid with respect to predetermined ones of said buyer and said supplier; and
earmarking the transference from said buyer corresponding to said real accounts for at least one of the payments of a supplier other than one of said supplier and a service provider other than said service provider who are not corresponding to the pertinent real account and the payment of at least one of a supplier and a service provider under a contract other than said contract.
